(19) United States
(12) Patent Application Publication
(10) Pub. No.: US 2020/0056071 A1
(43) Pub. Date: Feb. 20, 2020

(54) VAPOUR BARRIER, WHICH IS SELF-ADHESIVE ON ONE SIDE, FOR SEALING OFF FLOORS HAVING RESIDUAL MOISTURE

(71) Applicant: Uzin Utz Schweiz AG, Buochs (CH)

(72) Inventor: Thomas Wigger, Geuensee (CH)

(73) Assignee: Uzin Utz Schweiz AG, Buochs (CH)

(21) Appl. No.: 16/343,627

(22) PCT Filed: Oct. 20, 2017
(86) PCT No.: PCT/EP2017/076840

§ 371 Date: Apr. 19, 2019

(30) Foreign Application Priority Data
Oct. 21, 2016 (EP) 16195068.8

(51) Int. Cl. C09J 7/29; C09J 7/38; C09J 5/00; E04B 1/62; B32B 5/02; B32B 7/06; B32B 7/12; B32B 27/32; B32B 27/12

(52) U.S. Cl. CPC C09J 7/29; B32B 2405/00; C09J 7/385; C09J 5/00; E04B 1/625; B32B 5/022; B32B 7/06; B32B 7/12; B32B 27/32; B32B 27/12; C09J 2400/143; C09J 2400/163; C09J 2433/00; C09J 2409/00; C09J 2423/046; B32B 2262/101; B32B 2255/205; B32B 2255/10; B32B 2307/7246; C09J 7/383

(57) ABSTRACT

The invention relates to a vapor barrier which is self-adhesive on one side, comprising at least one moisture barrier layer, a carrier film and a first pressure-sensitive adhesive layer which is resistant to moisture, wherein a structured surface and/or a textile structure is present on the side of the carrier film opposite the first pressure-sensitive adhesive layer.

The present invention relates to a vapor barrier which is self-adhesive on one side, comprising at least one moisture barrier layer, a carrier film and a first pressure-sensitive adhesive layer which is resistant to moisture, wherein a structured surface and/or a textile structure is present on the side of the carrier film opposite the first pressure-sensitive adhesive layer.

To produce new concrete floors and screeds, considerable amounts of water are required in order to achieve a suitable consistency. A large part of this water has to evaporate, or dry off, after the setting process before further layers can be applied or before a floor covering can finally be applied. Complete drying of concrete slabs requires many months up to about 3 years. Complete drying of screeds requires, depending on thickness, construction, composition and prevailing atmospheric conditions in the room, from several weeks to months. In order to be able to build up the next layers on the floor, the moisture in the floor, for example a concrete floor or a screed, usually has to have dried off to a prescribed degree.

In order to shorten the delay time further, screeds and/or concrete floors containing residual moisture are provided with, for example, reactive vapor barriers, for example with 2K (2-component) epoxy, 2K-PU (polyurethane) or sometimes 1K-PU or 1K-silane coatings. These have to be applied in a plurality of layers, depending on the barrier action required. The last layer is usually sanded. After loose sand has been swept off, a troweling composition can be applied and, for example, an elastic floor covering, a carpet or parquetry can be adhesively bonded to the dried troweling composition layer, for example by means of a dispersion adhesive or a reactive adhesive.

However, reactive vapor barriers and vapor barrier systems often present health problems during processing, since harmful, irritating, toxic or mutagenic crosslinkers are sometimes used. In addition, drying times of up to 24 hours are usually required for each application of a layer in order to be able to continue with the next operation.

Vapor barrier layers are often laid loose between concrete slab and screed in order to protect the screed against the moisture in the concrete slab. Underlays having vapor barrier properties, which are either made self-adhesive on one side and are adhesively bonded onto the substrate, or nonadhesive underlays which are laid loose on the substrate or are adhesively bonded wet or conventionally onto the substrate, are sometimes also used on the screeds or on troweled substrates. Subsequently, a floor covering can be adhesively bonded to these underlays, for example using wet adhesives or conventional adhesives. This requires long drying times since these underlays cannot take up the moisture from the adhesives and are “nonabsorptive”. These underlays are often from 1 to 5 mm thick and sometimes also have footfall-damping properties. In particular, it is usually necessary to wait for at least 24 to 72 hours after laying of the floor covering before the freshly laid floor covering can be subjected to loads. Otherwise, squashing of the adhesive layer and/or a poor visual appearance has to be reckoned with. Owing to the thickness and ductility of the underlays, many floor coverings cannot be laid thereon.

Although these underlays can be laid quickly, they do not offer sufficient laying comfort. In most cases, they have only a small and therefore unsatisfactory ability to equalize unevennesses, so that a troweled or flat-ground substrate generally has to be present to accommodate the vapor barrier.

Vapor barriers for various substrates are known, for example, from DE 10 2011 011292 A1.

There is a need to provide a vapor barrier system which allows quick laying of same on raw substrates containing residual moisture, for example concrete or cement screeds, without additional drying times and delay times, and onto which conventional, mineral troweling compositions can be applied directly. Floor coverings of all types should subsequently be able to be adhesively bonded onto this troweling composition. As an alternative, a covering such as parquetry should be able to be adhesively bonded directly, for example by means of a reactive adhesive, onto the vapor barrier system. The vapor barrier system should seal the substrate containing residual moisture to a sufficient extent, so that a floor, optionally after application of troweling composition for leveling the floor, can be laid quickly on top of the vapor barrier system, with unevenesses of the substrate containing residual moisture also being able to be tolerated here.

The invention provides a vapor barrier, which is self-adhesive on one side, having a vapor barrier, preferably a vapor block, which quickly and easily leads to the objective, with a further layer being able to be applied by troweling or adhesive bonding directly on top of the self-adhesive vapor barrier. Advantageously, no delay times or drying times are required for this purpose.

According to a first aspect, the present invention provides a vapor barrier which is self-adhesive, comprising:
at least one carrier film;
at least one moisture barrier layer; and
a first pressure-sensitive adhesive layer which is resistant to moisture and is present on a side of the self-adhesive vapor barrier facing the surroundings, wherein a textile structure and optionally a polysiloxane layer and/or another locking-reducing layer and/or a removable covering layer has been applied to the carrier film on a side of the self-adhesive vapor barrier facing the surroundings on the side opposite the first pressure-sensitive adhesive layer and/or the carrier film is structured on the side opposite the first pressure-sensitive adhesive layer and optionally has a polysiloxane layer and/or another locking-reducing layer and/or a removable covering layer,
   wherein the first pressure-sensitive adhesive layer has, after application to a moisture-saturated fibrocement sheet, a peel resistance measured by a method based on DIN EN 1939:2003 of ≥3.0 N/25 mm, and
   wherein the first pressure-sensitive adhesive layer has a peel resistance measured by a method based on DIN EN 1939:2003 of ≥3.0 N/25 mm after accelerated aging on a moisture-saturated fibrocement sheet for 20 days, preferably for 28 days, more preferably for 41 days, at 50° C. with retention of the moisture content.

According to a further aspect, the present invention provides for the use of the self-adhesive vapor barrier according to the invention for laying on a substrate containing residual moisture.

In addition, the present invention provides a method for applying a self-adhesive vapor barrier to a substrate containing residual moisture, comprising:
application of the self-adhesive vapor barrier according to the invention to the substrate containing residual moisture, wherein the first pressure-sensitive adhesive layer is applied to the substrate containing residual moisture, and the removable covering layer or the removable covering layers is/are optionally removed before, during or after application of the self-adhesive vapor barrier.

Further aspects of the present invention can be derived from the dependent claims and the detailed description.

### DEFINITIONS

For the purposes of the invention, moisture saturation is a state in which a material, body or field, e.g. a fibrocement sheet, has taken up such a large amount of moisture that further uptake would under the ambient conditions lead to an energetically less favorable state, in particular at a standard pressure of 101,325 Pa and a temperature of from 5 to 95° C., in particular a room temperature of from 20 to 25° C., and also at an elevated temperature of, for example, 50° C. This can be ensured by the fibrocement sheet always being present in water so that the fibrocement sheet can optionally take up further water.

A pressure-sensitive adhesive is a physically adhering adhesive which, after application to a carrier material such as a carrier film, remains highly viscous and tacky in the long term and can then be applied by means of pressure to a substrate and remain adhering there. In contrast to chemically or physically curing adhesives, pressure-sensitive adhesives do not have setting processes.

Pressure-sensitive adhesive layers, e.g. of adhesive tapes, are pressure-sensitively adhesive because of their physicochemical properties, with the adhesion being determined by physical effects. In contrast to some reactive adhesives, pressure-sensitive adhesive layers cannot form any chemical bonds with a substrate. Microscopic interfacial effects, e.g. wetting of the substrate surface, which is partly determined by the “softness” of the pressure-sensitive adhesive layer, are important for the achievement of adhesion. However, it is basically important to achieve a very large-area, intimate contact between a pressure-sensitive adhesive layer and a substrate.

Many adhesive systems utilize changes of state, e.g. as a result of drying, crosslinking, cooling, etc., firstly to achieve the desired areal contact and secondly to have still enough cohesion for force transmission, namely adhesive effect. These changes of state are brought about by chemical (e.g. crosslinking, polymerization, etc.) or physical (e.g. cooling, evaporation of solvents, etc.) setting processes. These possibilities are not present in the case of pressure-sensitive adhesive layers. These have to be sufficiently “soft” for intimate areal contact and at the same time be sufficiently “hard” or cohesive to be able to transmit the adhesive forces. Pressure-sensitive adhesives are thus viscoelastic materials. These materials are not pure materials but instead always industrial mixtures or materials which are made up of many substances, e.g. polymers of differing molar mass, differing sequence, starter molecules, emulsifiers, stabilizers, reaction regulators, solubilizers, etc. The parameters important for the properties of the resulting materials are not available to a person skilled in the art for the development of industrial chemical products in building and construction.

It is generally postulated that to achieve adhesive tack, the glass transition temperature of the pressure-sensitive adhesive layer has to be at least 15 K to about 35 K below the processing temperature. Furthermore, the adhesion is influenced by various forces of attraction and repulsion, e.g. van der Weals forces, dipole forces, etc. Here, the chemical nature of the participating surfaces plays an important role, but this is in practice never known in sufficient detail.

Despite many opinions in respect of adhesion, there is not any reliable, calculatable model which indicates how the appropriate adhesion can be obtained for a particular substrate. However, it is known that the adhesion is determined not only by the properties of a pressure-sensitive adhesive layer or the properties of a substrate surface but instead arises only by interaction between the respective surfaces. This means that different degrees of adhesion are attained by means of a pressure-sensitive adhesive layer on various substrate surfaces, as will also be demonstrated by way of example below.

In general, the structure and properties of the substrate surfaces are only inadequately known to a person skilled in the art for the development of industrial chemical products and no detailed information about the precise chemical make-up of the raw materials is known. Only by means of empirical studies can the adhesion properties be determined and a fitting product thus be developed. In reality, a person skilled in the art therefore has to formulate suitable approaches to a solution for development of industrial chemical products from the possible raw materials available and test these in a targeted manner. In summary, the detailed chemical constituents of the adhesives are not relevant to the industrial development of self-adhesive products, since firstly the relevant information regarding the surfaces, the adhesives and further participating materials and also an applicable, reliable theory regarding the adhesion mechanisms are entirely missing.

For this reason, pressure-sensitive adhesives and pressure-sensitive adhesive layers produced therefrom are still usually characterized by means of parameters as are described in, for example, “Pressure Sensitive Adhesive Tapes, A guide to their function, design, manufacture, and use”, John Johnston, 2013, chapter 2 “How pressure sensitive adhesives work”, chapter 8 “Design”, and chapter 9 “Testing”. The development of such parameters is therefore of great interest to a person skilled in the field in order to be able to take these into account in further product development and also in specific projects.

A reasonable range of raw materials can then be selected for targeted tests in collaboration with raw materials suppliers. Targeted empirical experiments by means of the defined features, when they have been correctly determined, lead with justifiable effort to the objective.

In the case of known products, for example packaging tapes, which are merely being modified or optimized, the relevant features are known. However, the relevant features firstly have to be determined for different products, for instance for self-adhesive vapor barriers for laying on substrates containing residual moisture. In the light of this background, the present invention has been made.

The first aspect of the present invention relates to a self-adhesive vapor barrier, comprising:
at least one carrier film;
at least one moisture barrier layer; and
a first pressure-sensitive adhesive layer which is resistant to moisture and is present on a side of the self-adhesive vapor barrier facing the surroundings, wherein a textile structure and optionally a polysiloxane layer and/or another locking-reducing layer and/or a removable covering layer has been applied to the carrier film on a side of the self-adhesive vapor barrier facing the surroundings on the side opposite the first pressure-sensitive adhesive layer and/or the carrier film is structured on the side opposite the first pressure-sensitive adhesive layer and optionally has a polysiloxane layer and/or another locking-reducing layer and/or a removable covering layer,
   wherein the first pressure-sensitive adhesive layer has, after application to a moisture-saturated fibrocement sheet, a peel resistance measured by a method based on DIN EN 1939:2003 of ≥3.0 N/25 mm, preferably ≥6.0 N/25 mm, and
   wherein the first pressure-sensitive adhesive layer has a peel resistance measured by a method based on DIN EN 1939:2003 of ≥3.0 N/25 mm, preferably ≥6.0 N/25 mm, after accelerated aging on a moisture-saturated fibrocement sheet for 20 days, preferably for 28 days, more preferably for 41 days, at 50° C. with retention of the moisture content.

The first aspect of the present invention therefore relates to a self-adhesive vapor barrier, comprising:
at least one carrier film;
at least one moisture barrier layer; and
a first pressure-sensitive adhesive layer which is resistant to moisture and is present on a side of the self-adhesive vapor barrier facing the surroundings, wherein a textile structure has been applied to the carrier film on a side of the self-adhesive vapor barrier facing the surroundings on the side opposite the first pressure-sensitive adhesive layer and/or the carrier film is structured on the side opposite the first pressure-sensitive adhesive layer,
   wherein the first pressure-sensitive adhesive layer has, after application to a moisture-saturated fibrocement sheet, a peel resistance measured by a method based on DIN EN 1939:2003 of ≥3.0 N/25 mm, preferably ≥6.0 N/25 mm, and
   wherein the first pressure-sensitive adhesive layer has a peel resistance measured by a method based on DIN EN 1939:2003 of ≥3.0 N/25 mm, preferably ≥6.0 N/25 mm, after accelerated aging on a moisture-saturated fibrocement sheet for 20 days, preferably for 28 days, more preferably for 41 days, at 50° C. with retention of the moisture content. A polysiloxane layer and/or another locking-reducing layer and/or a removable covering layer can optionally have been applied to the textile structure, and/or the carrier film can optionally have a polysiloxane layer and/or another locking-reducing layer and/or a removable covering layer on the structuring.

A self-adhesive vapor barrier here is a film which is able to adhere to a substrate by means of at least one pressure-sensitive adhesive layer. In addition, the first pressure-sensitive adhesive layer is resistant to moisture as a result of satisfactory fastening to a substrate containing residual moisture being ensured, which can be determined, for example, via the peel resistance. This resistance is also present after aging.

For the purposes of the present invention, a vapor barrier is a barrier to migrating or diffusing moisture; for example generally to diffusion of water, for example osmosis.

The measurement of the peel resistance is, according to the invention, carried out in a manner analogous to DIN EN 1939:2003 using the identical test methods but using project-specific substrates. This means that the overall test is carried out precisely in accordance with the provisions of DIN EN 1939:2003, but the substrate indicated there is replaced by the present, moisture-saturated fibrocement sheet. The materials indicated in the standard do not make it possible to simulate a substrate which contains residual moisture and comes into contact with and is joined to the self-adhesive vapor barrier of the invention during actual laying.

According to the standard, the measurement is carried out after application according to the method indicated in the standard or after accelerated aging. Testing is in each case carried out under standard atmospheric conditions, i.e. at 23° C. and 50% atmospheric humidity, also after accelerated aging.

Adhesive forces on standard substrates such as steel (V2A) or glass are usually reported on data sheets. It has been found that the measured values given on the data sheets can serve merely as starting point for a rough selection of adhesives and these have to be specifically tested in each case.

In development of a product, it is quite common that in order to select an adhesive it will be necessary to test the adhesive properties of the respective pressure-sensitive adhesives on the project-specific substrates and also the project-specific floor coverings and also the resistance to the conditions occurring in the planned use. This applies particularly to adhesives which are to be adhesively bonded to substrates containing residual moisture. A moisture-saturated fibrocement sheet is therefore used instead of a substrate made of stainless steel for the present measurement of the peel resistance.

However, the measurement is otherwise carried out in accordance with DIN EN 1939:2003. For this purpose, test specimens in accordance with DIN EN 1939:2003 are produced and adhesively bonded to both dry and moisture-saturated fibrocement sheets and tested in accordance with the methods described in DIN EN 1939:2003.

The moisture saturation of the fibrocement sheet can, for example, be achieved here by the fibrocement sheet being laid in, for example, deionized water so that it is just not covered or just covered levelly with water, i.e. until an upper edge is surrounded on all sides by water or the upper side of the fibrocement sheet is covered by just a minimal amount of water, for example a water level having a height of less than 1 cm, for example less than 0.5 cm, 0.3 cm or 0.1 cm. On the underside, the fibrocement sheet can be located on the bottom of a suitable vessel for the water which does preferably not intervene in the system of water and fibrocement and preferably also does not react with the water, for example a vessel made of stainless steel.

For the present purposes, a fibrocement sheet is a commercial, untreated fibrocement sheet, for example Eterplan from Eternit.

In particular embodiments, the first pressure-sensitive adhesive layer also has, after application to a dry fibrocement sheet, a peel resistance measured by a method based on DIN EN 1939:2003 of ≥3.0 N/25 mm, preferably ≥6.0 N/25 mm.

For years of adhesion to moist substrates to function, not only should the initial adhesion be sufficient but it should also be ensured that the required adhesion properties are maintained over the entire life of a floor covering laid thereon. The life of floor coverings can be up to 20 years; the covering is often worn after 5-10 years and should be changed.

The resistance of the first pressure-sensitive adhesive layer of the inventive, self-adhesive vapor barrier with the barrier layer for or against moisture, for example also referred to as vapor barrier, can be determined by peel test specimens being produced by a method based on DIN EN 1939:2003 on moist fibrocement sheets and these being subjected to accelerated aging in the moist state at elevated temperature. The storage time should for this purpose be matched to the period of use expected.

The first pressure-sensitive adhesive layer therefore also has a peel resistance measured by a method based on DIN EN 1939:2003 of ≥3.0 N/25 mm, preferably ≥6.0 N/25 mm, after accelerated aging on a moisture-saturated fibrocement sheet for 20 days, preferably for 28 days, more preferably for 41 days, at 50° C. with retention of the moisture content. Here, the test specimens are likewise produced in accordance with DIN EN 1939:2003, with these then being aged for 20 days, preferably for 28 days, more preferably for 41 days, at 50° C. with retention of the moisture content. The storage or aging for 20 days, preferably for 28 days, more preferably for 41 days, at 50° C. with retention of the moisture content here models a long-term action of moisture. Retention of the moisture content ensures that the fibrocement sheet and also further constituents of the test specimen do not dry out and the moisture saturation of the fibrocement sheet is retained and can be ensured in a suitable way, for example by appropriate after-moistening and/or storage in a closed room having a controlled humidity. After aging, the peel resistance is again tested by the methods described in DIN EN 1939:2003.

In particular embodiments, the peel resistance does not decrease during the accelerated aging on a moisture-saturated fibrocement sheet for 20 days, preferably for 28 days, more preferably for 41 days, at 50° C. with retention of the moisture content compared to the point in time of the measurement after application, for example 15 minutes after application, to a moisture-saturated fibrocement sheet.

On mineral substrates, for example concrete, cement screed, cement-based troweling compositions, etc., both the surface and the migrating moisture can be alkaline. pH values in the range from 8.0 to 13.5 are quite normal and occur in practice. The pH values of the surfaces or of migrating moisture can be measured by means of a suitable pH test strip in accordance with ASTM F710-11, paragraph 5.2 (ASTM F710-11, Standard Practice for Preparing Concrete Floors to Receive Resilient Flooring, ASTM International, West Conshohocken, Pa., 2011).

In particular, the first pressure-sensitive adhesive layer therefore also has a sufficient resistance to alkaline moisture. In particular embodiments, the first pressure-sensitive adhesive layer is therefore resistant to alkaline moisture having a pH of equal to or more than 8.0 and equal to or less than 13.5, preferably equal to or more than 8.5 and equal to or less than 13.0. The resistance is advantageously present both at the beginning of application or laying and also after aging, so that the first pressure-sensitive adhesive layer thus has a peel resistance measured by a method based on DIN EN 1939:2003 of ≥3.0 N/25 mm, preferably ≥6.0 N/25 mm, after application to a moisture-saturated fibrocement sheet at a pH of equal to or more than 8.0 and equal to or less than 13.5, preferably equal to or more than 8.5 and equal to or less than 13.0, and/or the first pressure-sensitive adhesive layer has a peel resistance measured by a method based on DIN EN 1939:2003 of ≥3.0 N/25 mm, preferably ≥6.0 N/25 mm, after accelerated aging on a moisture-saturated fibrocement sheet for 20 days, preferably for 28 days, more preferably for 41 days, at 50° C. with retention of the moisture content at a pH of equal to or more than 8.0 and equal to or less than 13.5, preferably equal to or more than 8.5 and equal to or less than 13.0. The alkalinity in the range from pH 8.0 to 13.5 can, for example, be achieved by moistening of fibrocement sheets with deionized water. If required, the pH can be set in a targeted manner by addition of dilute sodium hydroxide solution.

Here too, preference is given to the peel resistance not decreasing during aging.

Since the first pressure-sensitive adhesive layer comes into contact with the substrate containing residual moisture during laying and therefore, viewed from the substrate containing residual moisture, is located in the self-adhesive vapor barrier according to the invention below or under the carrier film, it can also be referred to as lower pressure-sensitive adhesive layer.

In respect of the first pressure-sensitive adhesive layer, the expression “facing the surroundings” means that there is no optional removable covering layer and there is no longer any further adjoining layer which belongs to the self-adhesive vapor barrier according to the invention but instead the first pressure-sensitive adhesive layer forms a surface of the self-adhesive vapor barrier of the invention. Of course, this first pressure-sensitive adhesive layer can during further processing of the self-adhesive vapor barrier, for example during laying, come into contact with the substrate which then forms the surroundings. The surroundings thus do not necessarily have to be air.

The first pressure-sensitive adhesive layer is not subject to any particular restrictions in respect of its configuration and can also be matched to a substrate containing residual moisture on which the self-adhesive vapor barrier of the invention is to be laid by being, for example, flat or structured in order to obtain, if necessary, better bonding to a rough substrate.

In particular embodiments, the first pressure-sensitive adhesive layer has an adhesive application mass of 10-200 g/m², preferably 30-200 g/m², with this being able to be, in particular embodiments, 40-180 g/m² or 50-160 g/m², for example depending on the field of application and substrate.

The material of the first pressure-sensitive adhesive layer is not subject to particular restrictions, as long as it brings about the appropriate moisture resistance of the first pressure-sensitive adhesive layer and adheres to a preferably mineral substrate containing residual moisture, and can also encompass mixtures of materials. In particular embodiments, the first pressure-sensitive adhesive layer is present as hot-melt adhesive, solvent-based adhesive or dispersion adhesive, preferably as hot-melt adhesive or solvent-based adhesive, particularly preferably as hot-melt adhesive, which are made purely physically curing and/or chemically and/or physically post-crosslinking.

In particular embodiments, the first pressure-sensitive adhesive layer can consist of or comprise a pressure-sensitive adhesive material selected from the group consisting of pressure-sensitive adhesives based on rubber, natural rubber, synthetic rubber such as styrene-butadiene block copolymers (SBS), acrylate, chloroprene rubber, polyurethane, styrene-acrylate, vinyl acetate, vinyl acetate-ethylene, vinyl versatate, polyethylene-vinyl acetate, polyethylene-vinyl versatate, polyacrylate, and/or mixtures and/or copolymers thereof, preferably pressure-sensitive adhesives based on rubber, natural rubber, synthetic rubber such as SBS block copolymers, polyurethane, polyacrylate, polyethylene-vinyl acetate, polyethylene-vinyl versatate and/or mixtures and/or copolymers thereof, particularly preferably pressure-sensitive adhesives based on rubber, natural rubber, synthetic rubber such as SBS block copolymers, chloroprene rubber and/or mixtures and/or copolymers thereof, with preference again being given to hot-melt adhesives (hot melts) and/or solvent-based adhesives.

In addition to the first pressure-sensitive adhesive layer, the self-adhesive vapor barrier according to the invention further comprises at least one carrier film. The carrier film can here be configured in the form of a single-layer or multilayer film having two or more layers or else as composite material.

In particular embodiments, the carrier film comprises one or more, for example one, film carrier(s) onto which one or more different layers such as the first pressure-sensitive adhesive layer, one or more moisture barrier layers, for example one moisture barrier layer and/or a textile structure can be applied, where the textile structure can be configured as separate layers or can be part of the carrier film, but the moisture barrier layer can again also be joined as part of the carrier film with the film carrier or another layer in a multilayer composite, i.e. be integrated into the carrier film or be part of the carrier film. In particular embodiments, the carrier film consists of one or more, for example one, film carrier(s). In particular embodiments, the film carrier itself can also, so that it functions as moisture barrier, be provided as moisture barrier layer, i.e. can function both as carrier film and as moisture barrier layer. In particular embodiments, film carrier and moisture barrier layer are different.

The material of the film carrier is not subject to any particular restrictions as long as the further layers can be applied. For example, the film carrier can be configured as metal foil or metal layer or polymer film. As polymer, the material can also be foamed. In particular embodiments, the film carrier or the carrier film consists of a polymer material.

The polymer of the film carrier or the carrier film is not subject to any particular restrictions here and can, for example, comprise polymer materials or consist of polymer materials selected from the group consisting of polyethylene (PE), polypropylene (PP), aromatic and/or aliphatic polyamides (PA), aliphatic and/or aromatic polyesters (PES), polyethylene-propylene (PEP), polyethylene terephthalate (PET), polylactide (PLA), polymethyl methacrylate (PMMA), polyolefins (PO), polyvinyl butyral (PVB), polybutadiene, neoprene, latex, nitrile rubber (NBR), styrene-butadiene rubber (SBR), polyvinyl chloride (PVC), polycarbonate (PC), polyacrylic ester (PAA), polyacrylonitrile (PAN), polyamidimide (PAI), polybutyl acrylate (PBA), polyesteramide (PEA), polyetherimide (PEI), polyether ketone (PEK), polyether carbonate (PEC), polyimide (PI), polyacrylic ester imide such as polymethacrylic methylimide (PMMI), polyoxymethylene (POM), polyphenylvinyl (PPV), polystyrene (PS), polyurethane (PUR), polyvinyl acetate (PVAC), polyvinyl alcohol (PVOH), polyvinyl fluoride (PVF) or copolymers and/or mixtures thereof, preferably from the group consisting of polyethylene (PE), polypropylene (PP), aromatic and/or aliphatic polyamides (PA), aliphatic and/or aromatic polyesters (PES), polyethylene-propylene (PEP), polyethylene terephthalate (PET), polylactide (PLA), polyacrylonitrile (PAN), polymethyl methacrylate (PMMA), polyolefins (PO), polyvinyl butyral (PVB), polybutadiene, neoprene, latex and/or polyvinyl chloride (PVC) and/or copolymers and/or mixtures thereof. In particular embodiments, the film carrier or the carrier film comprises polyethylene (PE), polypropylene (PP), polyethylene-propylene (PEP), polyolefins (PO), polyvinyl chloride (PVC), polyacrylonitrile (PAN), latex, nitrile rubber (NBR) and/or styrene-butadiene rubber (SBR) and/or copolymers and/or mixtures thereof and/or consists thereof.

If a foam is used or concomitantly used for the film carrier or the carrier film or a layer in a multilayer carrier film, the foam preferably consists of a polymer material from the group consisting of polyethylene (PE), polypropylene (PP), aromatic and/or aliphatic polyamides (PA), aliphatic and/or aromatic polyesters (PES), polyethylene-propylene (PEP), polyether, polyurethane, polyethylene terephthalate (PET), polylactide, polyolefins, polyvinyl butyral, polybutadiene, neoprene, latex and/or polyvinyl chloride and/or copolymers and/or mixtures thereof.

If, for example, the material of the film carrier or the carrier film and/or the pressure-sensitive adhesive layer is sensitive to plasticizers, the self-adhesive vapor barrier according to the invention further comprises, in particular embodiments, at least one barrier layer which is impermeable to plasticizers. In particular embodiments, the self-adhesive vapor barrier according to the invention further comprises at least one barrier layer which is impermeable to plasticizers. A plurality of barrier layers for plasticizers being present is not ruled out. Such a barrier layer to plasticizers is preferably located on one side of the self-adhesive vapor barrier from which introduction of plasticizer is to be feared or to be expected after laying and processing of the self-adhesive vapor barrier, i.e., for example, from the upper side from various floor coverings, which corresponds to the side on which a textile structure and optionally a polysiloxane layer has been applied and/or the carrier film is structured and optionally has a polysiloxane layer. If plasticizer introduction from the direction of the floor is to be feared, a barrier layer which is impermeable to plasticizers can also be arranged on the film carrier or the carrier film in the direction of the first pressure-sensitive adhesive layer. A barrier layer which is impermeable to plasticizers is here preferably a layer which does not allow any plasticizer to pass through.

The material of the barrier layer which is impermeable to plasticizers is not subject to any particular restrictions here as long as it prevents passage of plasticizers and is, for example, polymeric, metallic and/or ceramic, i.e. comprises one or more polymers, metals and/or ceramics and/or consists thereof. As barrier layer which is impermeable to plasticizers, it is possible to employ, for example, a layer which contains a metal, a metal oxide and/or a polymer encompassing polyethylene terephthalate (PET), aromatic and/or aliphatic polyamides (PA), aliphatic and/or aromatic polyesters (PES), polymethyl methacrylate (PMMA), polyacrylonitrile (PAN), polyvinyl chloride (PVC), polycarbonate (PC), polyurethane (PUR), polyvinyl acetate (PVAC), polyvinyl alcohol (PVOH) and/or copolymers and/or mixtures thereof, preferably polyethylene terephthalate (PET), aromatic and/or aliphatic polyamides (PA), polyacrylonitrile (PAN), polyvinyl alcohol (PVOH) and/or polymethyl methacrylate (PMMA) and/or copolymers and/or mixtures thereof, and/or consists thereof.

In particular embodiments, the at least one barrier layer which is impermeable to plasticizers is a polymer layer which has a thickness of from 1 to 200 μm and/or a metal or metal oxide layer which has a thickness of from 10 nm to 100 μm, preferably a polymer layer which has a thickness of from 10 μm to 150 μm, preferably from 15 to 100 μm, more preferably from 20 to 60 μm, and/or a metal or metal oxide layer which has a thickness of from 15 nm to 50 μm, preferably 20 nm-30 μm.

In particular embodiments, the at least one moisture barrier layer and/or the optional at least one barrier layer which is impermeable to plasticizers is/are integrated into the carrier film. They can thus, for example, have been applied to the film carrier and/or another layer in a multilayer structure of the carrier film, or the film carrier can perform one or both functions, i.e. the plasticizer barrier and/or the barrier to moisture. Thus, the carrier film can contain at least one plasticizer-blocking layer, i.e. a barrier layer which is impermeable to plasticizers, in particular a layer which has a barrier action in respect of organic substances which are capable of migration, and/or at least one moisture barrier layer, in particular a layer which has a barrier action in respect of water vapor.

In particular embodiments, the carrier film has, in a measurement of the compressive strength in accordance with DIN EN ISO 24343-1:2012, an indentation after static loading of 0.1 mm and a permanent indentation after static loading of ≤0.1 mm. In this way, good application of troweling composition and/or adhesive, etc., or good application of a floor covering after laying of the self-adhesive vapor barrier of the invention can be achieved. In particular, it can be ensured thereby that the carrier film is not too elastic and/or too compressible to allow simple application of troweling composition and/or adhesive, etc. In particular, the carrier film here is not foamed and/or does not comprise any foamed layers which lead to an excessively high deformability or ductility.

In particular embodiments, the film carrier has, in a measurement of the compressive strength in accordance with DIN EN ISO 24343-1:2012, an indentation after static loading of ≤0.1 mm and a permanent indentation after static loading of ≤0.1 mm.

Instead of DIN EN ISO 24343-1:2012, reference may also be made to SIA 253.011 in respect of the measurement.

In the self-adhesive vapor barrier of the invention, a textile structure and optionally a polysiloxane layer and/or another locking-reducing layer, for example a Teflon layer, and/or a removable covering layer has been applied to the carrier film on a side of the self-adhesive vapor barrier facing the surroundings on the side opposite the first pressure-sensitive adhesive layer and/or the carrier film is structured on the side opposite the first pressure-sensitive adhesive layer and optionally has a polysiloxane layer and/or another locking-reducing layer and/or a removable covering layer. On laying on the substrate, this corresponds to the upper side of the self-adhesive vapor barrier. Here, the expression “facing the surroundings” means that there is no longer any further adjoining layer which belongs to the self-adhesive vapor barrier according to the invention but instead this textile structure or optional polysiloxane layer and/or other locking-reducing layer and/or removable covering layer and/or structuring with optional polysiloxane layer and/or other locking-reducing layer and/or removable covering layer forms a surface of the self-adhesive vapor barrier according to the invention.

Of course, this can in turn be covered in further processing of the self-adhesive vapor barrier, for example with troweling composition, adhesive, etc., so that the surroundings here do not have to be only air. Likewise, this layer can, in a rolled-up state of the self-adhesive vapor barrier, be at least partly opposite the first pressure-sensitive adhesive layer in the roll, but it preferably does not bond to the latter and on unrolling of the self-adhesive vapor barrier becomes detached again from the first pressure-sensitive adhesive layer.

As removable covering layer, it is possible to conceive of, for example, a detachable covering layer or a weakly adhering, detachable covering layer.

As a result of the use of a textile structure and/or the structuring of the carrier film, locking can be avoided on rolling-up and improved adhesion friendliness to a material to be applied later, for example a troweling composition, an adhesive or a floor covering, can be achieved. Preference is therefore given to at least the carrier film being provided with a textile structure on a side of the self-adhesive vapor barrier facing the surroundings on the side opposite the first pressure-sensitive adhesive layer or the surface of the carrier film being structured.

The optional polysiloxane layer and/or other locking-reducing layer can also prevent or reduce locking of the surface, so that such a polysiloxane layer and/or other locking-reducing layer is at least partly used in combination with the textile structure and/or the structured surface. Since a polysiloxane layer and/or other locking-reducing layer can, however, reduce the adhesion of a material to be applied later, e.g. a troweling composition and/or an adhesive, preference is given to not the entire textile structure and/or structured surface of the carrier film, preferably textile structure, being treated with polysiloxane and/or another locking-reducing material such as Teflon, but instead preferably less than 50%, more preferably less than 20%, in particular less than 10%, of the surface of the total textile structure and/or structured surface of the carrier film, based on the total surface area of the textile structure and/or structured surface of the carrier film, being treated, with a treatment, preferably for the textile structure but also for the structured surface, being preferred particularly in the region facing the surroundings, i.e., for example, at least partly comes into contact with the first pressure-sensitive adhesive layer on rolling-up of the self-adhesive vapor barrier. The deeper regions, preferably of the textile structure but also of the structured surface, which extend in the direction of the first pressure-sensitive adhesive layer are preferably not treated with polysiloxane and/or another locking-reducing material.

The structuring of the surface of the upper layer of the carrier film, i.e. on the side of the self-adhesive vapor barrier facing the surroundings on the side opposite the first pressure-sensitive adhesive layer, or use of a textile structure and/or treatment with a locking-reducing material, for example polysiloxane, makes it possible for a removable covering layer, which can reduce adhesion, not to have to be applied to the first pressure-sensitive adhesive layer, as a result of which problems in, for example, rolling-up, etc., of the self-adhesive vapor barrier according to the invention due to contacting of the first pressure-sensitive adhesive layer with the opposite surface can be reduced or prevented, so that, for example, rolls can easily be unrolled again. In particular embodiments, the adhesion of the first pressure-sensitive adhesive layer to the side of the self-adhesive vapor barrier facing the surroundings on the side with the textile structure and/or polysiloxane layer and/or other locking-reducing layer and/or structuring of the carrier film opposite the first pressure-sensitive adhesive layer on the side opposite the first pressure-sensitive adhesive layer is such that values of ≤5.0 N/25 mm, preferably ≤3.0 N/25 mm, particularly preferably ≤1.5 N/25 mm, are obtained in a measurement of the peel resistance, measured by a method based on DIN EN 1939:2003.

As an alternative thereto or in addition thereto, a removable covering layer, for example an adhesion-reducing covering layer, which is not subject to any further particular restrictions as long as it is removable and in particular is adhesion-reducing, can be provided on the first pressure-sensitive adhesive layer, where the definition of adhesion-reducing can, for example, be analogous to that above, i.e. values of ≤5.0 N/25 mm, preferably ≤3.0 N/25 mm, particularly preferably ≤1.5 N/25 mm, are obtained in a measurement of the peel resistance, measured by a method based on DIN EN 1939:2003, between the removable covering layer and the first pressure-sensitive adhesive layer.

In particular embodiments, the self-adhesive vapor barrier of the invention further comprises a removable covering layer which has been applied to the first pressure-sensitive adhesive layer on a side of the self-adhesive vapor barrier facing the surroundings opposite the carrier film and/or the first pressure-sensitive adhesive layer has an adhesion measured by a method based on DIN EN 1939 of ≤5.0 N/25 mm, preferably ≤3.0 N/25 mm, particularly preferably ≤1.5 N/25 mm, to the textile structure and optional polysiloxane layer and/or other locking-reducing layer applied to the carrier film and/or the structured surface of the carrier film with optional polysiloxane layer and/or other locking-reducing layer.

In addition or as an alternative, a removable covering layer can, as described above, be provided on the textile structure or the structured surface of the carrier film, which covering layer can have a low peel adhesion measured by a method based on DIN EN 1939:2003 of ≤5.0 N/25 mm, preferably ≤3.0 N/25 mm, particularly preferably ≤1.5 N/25 mm, on the upper surface of the film carrier, i.e., for example, the textile structure and/or structured surface, and can have been made adhesion-reducing on the opposite side of the covering layer.

In particular embodiments, a textile structure and optionally a polysiloxane layer and/or another locking-reducing layer, in particular a textile structure, has been applied to the carrier film on a side of the self-adhesive vapor barrier facing the surroundings on the side opposite the first pressure-sensitive adhesive layer. The textile structure makes it possible to achieve better unrollability and horizontal stability of the self-adhesive vapor barrier, which is advantageous in further processing, for example applying a troweling composition or adhesive on top of the textile structure.

Carrier film and textile structure are preferably firmly joined to one another. The material of the textile structure can differ from that of the carrier film or correspond thereto.

The textile structure is not subject to any particular restrictions, but is not closed over its area but instead is penetratable, in particular by paste-like and/or disperse systems such as troweling compositions and/or adhesives, and can, for example, be a woven fabric, a lay-up, a knitted fabric and/or a nonwoven. Suitable materials for the textile structure are, for example, glass or glass fibers, metal or metal fibers, polyethylene (PE), polypropylene (PP), aromatic and/or aliphatic polyamide (PA), aliphatic and/or aromatic polyesters (PES), polyacrylonitrile (PAN), polycarbonate (PC), polyvinyl chloride (PVC), polyolefin (PO), polyvinyl acetate (PVAC), polyurethane (PUR), polymethyl methacrylate (PMMA) and/or copolymers and/or mixtures and/or combinations thereof, preferably glass, PES, PC, PO, PE, PAN and/or copolymers and/or mixtures and/or combinations thereof.

The optional polysiloxane is also not subject to any particular restrictions, and it is possible to use, for example, a polysiloxane as is customarily used in the field of adhesive film production, label production, prepregs, etc., for example on various films. The material of another locking-reducing layer is also not restricted and can, for example, comprise Teflon, etc.

In addition, the structuring of the surface of the carrier film is also not subject to any particular restrictions and can be carried out by, for example, embossing, abrasion, roughening, scoring, laser treatment, etc., with, for example, score marks, channels, grid structures, embossing, etc., which due to their structure allow better three-dimensional joining to a material to be applied later, for instance adhesive and/or troweling composition, being able to be formed.

In particular embodiments, the textile structure applied to the carrier film and optional polysiloxane layer and/or another adhesion-reducing layer and/or the structured surface of the carrier film with optional polysiloxane layer and/or other locking-reducing layer, in particular the textile structure and/or structured surface of the carrier film, has such a nature on the side opposite the first pressure-sensitive adhesive layer that, on application of a troweling composition, a dispersion adhesive and/or a reactive adhesive, a peel resistance measured by a method based on EN 1372:2015 of at least 0.5 N/mm, preferably at least 0.8 N/mm, more preferably at least 1 N/mm, is achieved. This makes the surface adhesion-friendly. More preferably, the textile structure applied to the carrier film and/or the structured surface of the carrier film, in particular the textile structure, is at least briefly alkali-resistant on the side opposite the first pressure-sensitive adhesive layer, i.e., for example, to alkaline moisture in the pH range from 8.0 to 13.5, and/or has a certain stiffness.

A measurement based on EN 1372:2015 can, for example, be carried out as follows: To produce the test specimen for the test in accordance with the test method described in EN 1372:2015, the self-adhesive vapor barrier according to the invention with the first pressure-sensitive adhesive coating is laminated without bubbles onto, for example, an at least 50 μm thick o-PET film. A frame made of, for example, wood, metal or another solid material, for example having dimensions of 240×70×15 mm, is applied to the upper, nonadhesive side of the self-adhesive vapor barrier of the invention. On a narrow side of the frame, a polymer film strip having a size of 70×30 mm is applied directly to the self-adhesive vapor barrier according to the invention. A troweling composition to be tested or an adhesive to be tested is introduced into the frame and a fibrocement sheet, for example having dimensions of 69×239×8 mm, is adhesively bonded onto this. After curing of the troweling composition or the adhesive, the frame is removed. A strip having, for example, a width of 50.0 mm and a length of 240 mm is cut from the self-adhesive vapor barrier according to the invention using a suitable template. The self-adhesive vapor barrier according to the invention is extended on the sides of the polymer film strip with a PET strip having a width of, for example, 50 mm. These test specimens produced in this way are tested by a method based on the test method described in EN 1372:2015, for example after 7 days under standard conditions.

In particular, the uppermost carrier layer, i.e. the structured surface of the carrier film or the textile structure with, optionally, the adhesion-reducing layer or coating, is configured so that firstly no locking of the surface, for example on rolling-up, takes place and secondly materials such as troweling compositions and/or adhesives to be applied obtain sufficiently good anchoring during further processing.

The self-adhesive vapor barrier of the invention additionally comprises at least one moisture barrier layer, for example a layer which blocks moisture, and can also comprise a plurality of barrier layers and/or layers which block moisture.

In particular embodiments, the moisture barrier layer has an s_{D} value, measured in accordance with ASTM E 398-13, of at least 50 m, preferably at least 100 m, more preferably at least 200 m. A layer which blocks moisture has, for example, in particular an s_{D} value, measured in accordance with ASTM E 398-13, of at least 1500 m.

The at least one moisture barrier layer is not subject to any particular restrictions as long as it acts as barrier to moisture and can be, for example, polymeric, metallic and/or ceramic, for example a metal oxide layer.

Suitable metals are, for example, Al, Cu, Ag, Au, Ti, Cr, Ni, Pd and/or Pt, for example Al, Ag, Au, Pd and/or Cu, in particular Al and/or Cu, which can be provided as foil and/or can be present as coating, for example vapor-deposited.

Suitable metal oxides are, for example, aluminum oxide, silicon dioxide, titanium oxide, etc., or mixed oxides; with aluminum oxide, silicon oxide, aluminum-silicon oxide being particularly suitable.

The at least one moisture barrier layer can as polymer comprise, for example, a material, or consist of a material, which is selected from the group consisting of polypropylene (PP), polyethylene (PE), polyolefins (PO), latex, nitrile rubber (NBR), styrene-butadiene rubber (SBR), polycarbonate (PC), polyvinyl chloride (PVC), polyvinyl acetate (PVAC), polyurethane (PU) and/or copolymers and/or mixtures thereof, more preferably polypropylene (PP), polyethylene (PE), polyolefins (PO), latex, nitrile rubber (NBR), styrene-butadiene rubber (SBR), polyvinyl chloride (PVC) and/or copolymers and/or mixtures thereof.

In particular embodiments, the at least one moisture barrier layer and/or the optional barrier layer for plasticizers is/are a polymer layer composed of polymer material. As indicated above, the moisture barrier layer and/or barrier layer to plasticizers can, in particular embodiments, be integrated into the carrier film.

When the moisture barrier layer is provided as polymer layer, this has, according to particular embodiments, a thickness in the range from 10 μm to 1000 μm, preferably in the range from 20 μm to 500 μm, more preferably in the range from 50 μm to 300 μm. This gives a particular stability both in a mechanical respect and also in respect of barrier action against moisture when a polymer layer is used as moisture barrier layer. In the case of metals or metal oxides, the thickness of the moisture barrier layer is, according to particular embodiments, in a thickness range from 10 nm to about 100 μm.

When the barrier layer against plasticizers is provided as polymer layer, this has, according to particular embodiments, a thickness in the range from 1 μm to 200 μm, preferably in the range from 10 μm to 150 μm, more preferably in the range from 15 to 100 μm, even more preferably from 20 to 60 μm. When the barrier layer against plasticizers is provided as metal layer or metal oxide layer, this has, according to particular embodiments, a thickness of from 15 nm to 50 μm, preferably 20 nm-30 μm.

It is also conceivable for the carrier film to consist solely of a metallic vapor barrier and optionally plasticizer barrier which, according to particular embodiments, has a thickness of from 10 to 500 μm, preferably from 20 to 200 μm, more preferably from 30 to 100 μm.

In particular embodiments, the self-adhesive vapor barrier of the invention has a vapor barrier action or barrier action against moisture having an s_{D} value, measured in accordance with ASTM E 398-13, of at least 50 m, preferably at least 100 m, more preferably at least 200 m, even more preferably at least 500 m, particularly preferably at least 1500 m.

The self-adhesive vapor barrier according to the invention can be produced in various forms, for example in roll form, as strip or as plate, which can then be used suitably in the method of the invention. According to particular embodiments, the self-adhesive vapor barrier of the invention is produced in roll form.

In particular embodiments, the at least one moisture barrier layer is located between the at least one carrier film and the first pressure-sensitive adhesive layer and/or is in contact with the first pressure-sensitive adhesive layer. This is particularly advantageous when the carrier film is moisture-sensitive. There is, for example, the sequence of first pressure-sensitive adhesive layer/moisture barrier layer/carrier film/structured surface and/or textile structure, optionally treated with adhesion-reducing material. A barrier layer against plasticizers can here be provided, for example between the structured surface and the carrier film, integrated into the carrier film, between the moisture barrier layer and the carrier film, and/or the first pressure-sensitive adhesive layer and the moisture barrier layer, with appropriate account being able to be taken here of the resistance of the materials of the respective layer to plasticizers. It is also possible to provide a plurality of moisture barrier layers and/or carrier films and/or barrier layers against plasticizers. Furthermore, it is also conceivable for the moisture barrier layer also to act as barrier layer against plasticizers or for the carrier film to act as moisture barrier layer and/or barrier layer against plasticizers.

In particular embodiments, the moisture barrier layer can also be present on or integrated into the carrier film, on a side facing away from the first pressure-sensitive adhesive layer, for example when the carrier film is not moisture-sensitive. There is then, for example, the sequence of first pressure-sensitive adhesive layer/carrier film/moisture barrier layer/textile structure, optionally treated with adhesion-reducing material; or first pressure-sensitive adhesive layer/carrier film with integrated moisture barrier layer/structured surface and/or textile structure, optionally treated with adhesion-reducing material. A barrier layer to plasticizers can here be provided, for example between the structured surface and the moisture barrier layer, integrated into the carrier film, between the moisture barrier layer and the carrier film and/or the first pressure-sensitive adhesive layer and the carrier film, with appropriate account likewise being able to be taken here of the resistance of the materials of the respective layer to plasticizers. Once again, a plurality of moisture barrier layers and/or carrier films and/or barrier layers to plasticizers can also be provided. Furthermore, it is again conceivable for the moisture barrier layer also to act as barrier layer to plasticizers or for the carrier film to act as moisture barrier layer and/or barrier layer to plasticizers.

In addition, the present invention provides for the use of the self-adhesive vapor barrier of the invention for laying on a substrate containing residual moisture. Here, the vapor barrier can have a nature as is described in connection with the first aspect of the invention and thus also encompasses all embodiments presented there. In addition, the self-adhesive vapor barrier of the invention can be used for sealing a substrate containing residual moisture.

In particular embodiments, the substrate containing residual moisture is, in the case of the use according to the invention and also in the method of the invention, a residually moist substrate, for example having a mineral, preferably cement, basis, which has a residual moisture content which is above the values indicated in SIA 253:2002 (SIA Zurich), page 12, point 5.1.5.

Depending on the floor covering to be laid, the substrate moisture content has to be below particular limit values in order to achieve the readiness for laying. According to applicable rules in the field, for example in accordance with TKB information sheet 8, CM values of ≤2.0 CM-% have to be adhered to for readiness for covering in cement screeds for unheated surfaces and ≤1.8 CM-% for heated surfaces.

Substrates, for example mineral substrates, in particular cement-based substrates, which have higher moisture contents are considered in this sense to be “moist” or “residually moist”.

For example, cement screeds have to have, according to applicable rules in the field, or according to general interpretation of DIN 18365:2006, a moisture content of not more than 2.0 CM-% for the laying of elastic floor coverings.

In particular embodiments, the substrate containing residual moisture is a residually moist substrate having a mineral basis and a residual moisture content of more than 1.8 CM-%, preferably more than 2.0 CM-%, more preferably more than 2.5 CM-%, even more preferably more than 3.0 CM-%, particularly preferably equal to or more than 4.0 CM-%, measured in accordance with SIA 253:2002, calcium carbide method (CM), pages 16-17. With regard to the measurement, reference may also be made to the Technische Kommission Boden (TKB) des Industrieverbands Kleben, TKB information sheet 8, TKB information sheet 16 and also BEB (Bundesverband Estrich & Belag) technical information January/1998. Here, a substrate having a mineral basis is, for example, a cement screed and/or a concrete slab, etc. In particular embodiments, the substrate is, for example, not based on linoleum, a polymeric material, metal, gypsum and/or wood, for example parquetry, in particular not based on linoleum, a polymeric material, metal and/or wood.

In particular embodiments, the substrate containing residual moisture is a residually moist substrate having a mineral basis and a residual moisture content of not more than 6.0 CM-%, for example not more than 5.0 CM-%. It is also quite possible to seal cement screeds having a higher moisture content as long as they are fully set and able to withstand mechanical loads.

In a further aspect, the present invention provides a method for applying a moisture barrier layer to a substrate containing residual moisture, comprising:
application of the above-described self-adhesive vapor barrier according to the invention to the substrate containing residual moisture, wherein the first pressure-sensitive adhesive layer is applied to the substrate containing residual moisture, and the removable covering layer or the removable covering layers is/are optionally removed before, during or after application of the self-adhesive vapor barrier. In particular, a removable covering layer on the first pressure-sensitive adhesive layer is, if present, removed before or during application, while the removable covering layer on the textile structure and/or structured surface, optionally with adhesion-reducing layer, is preferably removed only after application and immediately before further processing. For this purpose, the covering layer on the textile structure and/or structured surface, optionally with adhesion-reducing layer, can have, for example, a weakly adhering layer and can be made easy-to-separate on the opposite side.

The application here corresponds to laying, preferably with bonding or adhesion occurring between the substrate containing residual moisture and the first pressure-sensitive adhesive layer of the self-adhesive vapor barrier, which leads to fastening of the self-adhesive vapor barrier to the substrate.

The self-adhesive vapor barrier of the invention can also be used in the method of the invention in all embodiments mentioned in conjunction with the first aspect in any possible combinations, with preferred embodiments of the method, and also of the use according to the invention, arising from preferred embodiments of the self-adhesive vapor barrier.

The definition of the substrate containing residual moisture corresponds to the definition in connection with the use according to the invention.

According to particular embodiments, the substrate containing residual moisture is a residually moist substrate having a mineral basis, for example a cement-based substrate, and having a residual moisture content of more than 1.8 CM-%, preferably more than 2.0 CM-%, more preferably more than 2.5 CM-%, even more preferably more than 3.0 CM-%, particularly preferably equal to or more than 4.0 CM-%, measured in accordance with SIA 253:2002.

In particular embodiments, a plurality of self-adhesive vapor barriers according to the invention are applied in an overlapping manner. Passage of moisture at the overlap positions or connecting places can be reduced or prevented in this way. In order to minimize unevennesses, the overlap can here be very small and/or very thin.

In particular embodiments, a plurality of self-adhesive vapor barriers according to the invention are applied so as to adjoin one another and at the adjoining places are joined using at least one one-sided or two-sided, for example one-sided, self-adhesive tape and/or at least one one-sided and/or two-sided, for example one-sided, self-adhesive tape is applied to the substrate containing residual moisture underneath the adjoining places of the self-adhesive vapor barriers according to the invention and the self-adhesive vapor barriers according to the invention are applied on top of the at least one one-sided and/or two-sided self-adhesive tape, so that the adjoining places of the self-adhesive vapor barriers according to the invention are located above the one-sided or two-sided self-adhesive tape, with the at least one one-sided and/or two-sided self-adhesive tape having at least one moisture barrier layer. In such embodiments, too, the area and/or thickness of the self-adhesive tape is preferably very small in order to minimize unevennesses.

Adjoining application here is, for example, application in an abutting manner with avoidance of overlaps, and joins through which residual moisture in the substrate can penetrate can be formed here. In order to prevent this, the one-sided or two-sided self-adhesive tapes are used. The one-sided or two-sided self-adhesive tapes preferably have a pressure-sensitive adhesive layer which is applied onto the substrate containing residual moisture and/or the self-adhesive vapor barrier of the invention, with this pressure-sensitive adhesive layer preferably corresponding in terms of its material to the first pressure-sensitive adhesive layer of the self-adhesive vapor barrier of the invention.

When a one-sided self-adhesive tape is applied to the substrate containing residual moisture and the self-adhesive vapor barrier of the invention is applied on top of this, the one-sided self-adhesive tape preferably has, as pressure-sensitive adhesive layer, a layer of this type which corresponds to the first pressure-sensitive adhesive layer of the self-adhesive vapor barrier of the invention, with this pressure-sensitive adhesive layer preferably being applied to the substrate containing residual moisture.

The one-sided and/or two-sided self-adhesive tapes preferably also comprise at least one moisture barrier layer which corresponds to those of the self-adhesive vapor barrier of the invention. They can additionally also contain at least one barrier layer against plasticizers.

In particular embodiments, on application or laying in an abutting manner on a self-adhesive vapor barrier according to the invention comprising a textile structure, this textile structure is cut out in adjoining zones and the at least one one-sided and/or two-sided self-adhesive tape is applied on this intermediate zone formed by the adjoining zones.

In particular embodiments, the at least one one-sided and/or two-sided self-adhesive tape is, in order to save material, only applied underneath the adjoining places or only above the self-adhesive vapor barriers of the invention; it is naturally also possible in the case of application of more than two self-adhesive vapor barriers according to the invention for the self-adhesive tape to be applied at one or more adjoining places underneath the self-adhesive vapor barriers according to the invention and to be applied on or above this at one or more other adjoining places to join the self-adhesive vapor barriers according to the invention.

Using both one-sided and also two-sided self-adhesive tapes, for example above and/or underneath the self-adhesive vapor barriers according to the invention, and overlapping of the self-adhesive vapor barriers according to the invention additionally taking place is not ruled out according to the invention, but this is not necessarily preferred in respect of avoiding greater unevennesses and increased consumption of material. When the self-adhesive vapor barrier of the invention is laid on partial areas or patches, it is optionally also possible to dispense with one-sided or two-sided self-adhesive tapes. In particular, one-sided or two-sided self-adhesive tapes are used in the case of a residual moisture content of the substrate of 2.5 CM-% or more, preferably 3.0 CM-% or more, and/or the self-adhesive vapor barriers according to the invention are applied in an overlapping manner.

In particular embodiments, the at least one moisture barrier layer of the at least one one-sided and/or two-sided self-adhesive tape has an s_{D} value, measured by a method based on ASTM E 398-13, of at least 50 m, preferably at least 100 m, more preferably at least 200 m.

In particular embodiments, an s_{D} value, measured by a method based on ASTM E 398-13, in each case of at least 20 m, preferably at least 50 m, more preferably at least 100 m, is attained at adjoining places sealed by means of tapes, for example joins, of two or more self-adhesive vapor barriers according to the invention.

In particular embodiments, in the method of the invention, a troweling composition, a dispersion adhesive and/or a reactive adhesive is/are applied on top of the textile structure and optional polysiloxane layer and/or other locking-reducing layer applied to the carrier film and/or the structured surface of the carrier film with optional polysiloxane layer and/or other locking-reducing layer. The troweling composition, the dispersion adhesive and the reactive adhesive are here not subject to any particular restrictions and can be determined appropriately for a floor to be laid thereon. As an alternative, for example in the case of sufficient evenness of the self-adhesive vapor barrier, or of the substrate, an appropriate floor can also be applied directly on top of the self-adhesive vapor barrier.

The above embodiments, configurations and further developments can, if meaningful, be combined with one another in any way. Further possible embodiments, further developments and implementations of the invention also encompass combinations which are not explicitly mentioned of features of the invention described above or in the following in the context of the working examples. In particular, a person skilled in the art will also add individual aspects as improvements or supplements to the respective basic form of the present invention.

The invention will now be presented with the aid of some illustrative embodiments which, however, do not restrict the invention.

Preliminary tests Various test specimens having an identical carrier film and different first pressure-sensitive adhesive layers or adhesives with an adhesive application mass of 10-200 g/m² were produced.

As adhesives, use was made of a dispersion-based polyacrylate as acrylate 1 (Vinnapas EAF 67, 2016), a polyacrylate hot melt as acrylate 2 (AC Resin A 204, 2016), a further polyacrylate hot melt as acrylate 3 (AC Resin A 250, 2016), a rubber hot-melt adhesive as SBS 1 (Artimelt T 231, 2016), a rubber hot-melt adhesive as SBS 2 (Novamelt PS 2050, 2016) and a further rubber hot-melt adhesive as SBS 3 (Novamelt PS 5020, 2016). Acrylate 1 is a polyacrylate dispersion, acrylate 2 and 3 are polyacrylate hot melts which are obtainable as 100% systems and behave differently, and SBS 1-3 are rubber hot melts for which no indications of the material constituents are available. In addition, a blend of acrylate 2 (4 parts by weight) and acrylate 3 (3 parts by weight) was produced by mixing the two polyacrylate hot melts in the specified ratio, and this is referred to as acrylate 4.

The adhesives were selected here in such a way that the effect of the invention of adhesion of the self-adhesive vapor barrier both after laying and also after aging can, with regard to long-term adhesion, be demonstrated clearly in the following examples. However, the adhesives used here do not constitute a restriction of the invention, and it may be pointed out that polyacrylate-based pressure-sensitive adhesives which satisfy the parameters defined according to the invention, and also other pressure-sensitive adhesives which are neither rubber adhesives nor polyacrylate adhesives are also known. However, these will not be discussed further here since the effect of the invention can clearly be seen from the following examples and comparative examples, and corresponding results are achieved using corresponding further adhesives which likewise have the appropriate peel resistances.

The test specimens were applied to a moisture-saturated fibrocement sheet and joined to this by the method described in DIN EN 1939:2003. After 15 minutes, the peel resistance was measured by the method described in DIN EN 1939:2003.

A residually moist substrate which on actual laying of the self-adhesive vapor barrier according to the invention comes into contact with and is bonded to the latter can be simulated in this way. Adhesive forces on standard substrates such as steel (V2A) or glass are mostly reported on data sheets. It has been found that the measured values reported on the data sheets can serve merely as starting point for a rough selection of adhesives and these then have to be specifically tested.

A commercial, untreated fibrocement sheet was used as fiber cement sheet.

For comparison, a measurement of the peel resistance by the method described in DIN EN 1939:2003 was additionally carried out after application of the test specimen to steel and glass and also a dry fibrocement sheet and joining to the latter, likewise after 15 minutes. The peel test was carried out under standard conditions of temperature and humidity.

In addition, test specimens applied and joined in this way to the moisture-saturated fibrocement sheets were aged for 28 days at 50° C. with retention of the moisture content and the peel resistance was subsequently measured again by the method described in DIN EN 1939:2003.

The pH of the moisture-saturated fibrocement sheet was additionally measured using a pH strip in accordance with ASTM F710-11, paragraph 5.2, and a pH of about 13.0 was obtained.

While a similar behavior of the adhesives is often observed on the dry substrates steel and glass and also fibrocement, a quite different behavior is surprisingly often found on moist substrates. The measured values for the peel tests using a method based on DIN EN1939:2003 after 15 minutes are shown in table 1.

TABLE 1
Measured values of the peel resistance after 15 minutes

| | | | | Fibrocement, | Fibrocement, |
|---|---|---|---|---|---|
| | | DIN steel | Glass | dry | moist |
| | Adhesive | [N/25 mm] | [N/25 mm] | [N/25 mm] | [N/25 mm] |
| 1 | Acrylate 1 | 6.9 | 9.3 | 9.1 | 0.07 |
| 2 | Acrylate 2 | 11.1 | 15.7 | 21.9 | 0.27 |
| 3 | Acrylate 3 | 41.6 | 62.2 | 39.5 | 4.00 |
| 4 | SBS 1 | 43.5 | 44.7 | 13.9 | 0.15 |
| 5 | SBS 2 | 35.6 | 42.4 | 31.9 | 7.97 |
| 6 | SBS 3 | 17.8 | 19.6 | 18.0 | 7.89 |
| 7 | Acrylate 4 | | | 28.6 | 5.2 |

For different, dry substrates, it is at least possible to draw analogous conclusions in respect of the adhesion properties of substrate to substrate for an adhesive. However, the peel force measurements on standardized substrates do not make it possible to draw conclusions as to the behavior of the adhesives on substrates containing residual moisture, as can be seen from table 1.

Table 2 shows the results of the peel tests for the test specimens on moisture-saturated fibrocement sheets after a contact time of 15 minutes and after moist storage at 50° C. for 28 days, with analogous values also being obtained after 41 days. Resistant pressure-sensitive adhesive layers here preferably do not display any decrease in the adhesion forces.

TABLE 2

| | | Fibrocement, moist 15′ | Fibrocement, moist |
|---|---|---|---|
| | Adhesive | [N/25 mm] | 28 days 50° C. [N/25 mm] |
| 1 | Acrylate 1 | 0.07 | 2.3 |
| 2 | Acrylate 2 | 0.27 | 9.0 |
| 3 | Acrylate 3 | 4.00 | 0.67 |
| 4 | SBS 1 | 0.15 | 7.2 |
| 5 | SBS 2 | 7.97 | 17.2 |
| 6 | SBS 3 | 7.89 | 0.86 |
| 7 | Acrylate 4 | 5.2 | 3.6 |

15′ = 15 Minutes

Which adhesives function for a project and which do not generally has to be assessed in each case with the aid of the project requirements. As minimum requirements, peel forces measured by a method based on DIN EN 1939:2003 of at least 3.0 N/25 mm should be achieved under all relevant conditions. This encompasses, for example, peel forces both on a dry fibrocement sheet and a moist fibrocement sheet and also on a moist fibrocement sheet after accelerated aging, at least after 20 days, preferably 28 days, more preferably 41 days, at 50° C. In addition, a decrease in peel force compared to 15 minutes should preferably not occur after accelerated aging.

In accordance with these requirements and from the measured data presented, it can be seen that acrylate 1 does not bring about satisfactory adhesion on a moist fibrocement sheet both after 15 minutes and also after accelerated aging. Acrylate 2 and SBS 1 have unsatisfactory initial adhesion to the moist fibrocement sheet and fail despite good values after accelerated aging. Acrylate 3 and SBS 3 display satisfactory short-term adhesion values on the moist fibrocement sheet, but are insufficiently resistant in a moist, alkaline medium. Satisfactory properties are displayed in this selection by SBS 2, with satisfactory adhesion values on a moist fibrocement sheet both after 15 minutes and also after accelerated aging after 20 days, preferably 28 days, more preferably 41 days, at 50° C. in an alkaline moist medium and also on dry substrates.

The peel force conditions are also satisfied by acrylate 4, which shows that the conditions can be satisfied not only with SBS or SIS copolymers.

### EXAMPLE 1

When SBS 2 is used as first pressure-sensitive adhesive layer, it is possible to produce a self-adhesive vapor barrier according to the invention which is joined to a nonwoven based on glass fibers on an upper side of a film carrier composed of polyethylene which has been coated by vapor deposition with an aluminum layer having a thickness of, for example, 50 nm, and on the other side of the film carrier is provided with the first pressure-sensitive adhesive layer.

A vapor barrier which is self-adhesive on one side and has a vapor barrier, which can be adhesively bonded onto cement-based substrates which are dry on the surface but contain residual moisture and can have a troweling composition or adhesive applied directly on top, is obtained. The carrier contains both a moisture barrier and a plasticizer barrier and the adhesive of the open side, i.e. the first pressure-sensitive adhesive layer, is designed for adhesive bonding on top of the substrate containing residual moisture. Even after accelerated aging, the vapor barrier which is self-adhesive on one side remains on a substrate containing residual moisture, as does a troweling composition applied thereto or an adhesively bonded floor on a cement-based substrate containing residual moisture.

Example 2 (Comparative example) In a manner analogous to example 1, a self-adhesive vapor barrier was produced by applying a pressure-sensitive adhesive layer composed of acrylate 1 opposite a glass fiber nonwoven layer to a film support which consists of polyethylene and has had an aluminum layer vapor-deposited thereon and is joined to the glass fiber nonwoven. This product also acts as a vapor barrier. However, it had only unsatisfactory initial adhesion on cement-based substrates containing residual moisture. As a result, a troweling composition could not be applied thereto with good quality, since the vapor barrier had distorted during application.

### EXAMPLE 3 (COMPARATIVE EXAMPLE)

In a manner analogous to example 1, a self-adhesive vapor barrier was produced by applying a pressure-sensitive adhesive layer composed of acrylate 3 opposite a glass fiber nonwoven layer to a film support which consists of polyethylene and has had an aluminum layer vapor-deposited thereon and is joined to the glass fiber nonwoven. This product also acts as a vapor barrier and has satisfactory initial adhesion to cement-based substrates containing residual moisture and can have a troweling composition applied on top. However, the troweling composition including the vapor barrier had become detached from the substrate after some days due to the setting stresses in the troweling composition and the unsatisfactory adhesion forces.

### EXAMPLE 4 (COMPARATIVE EXAMPLE)

In a manner analogous to example 1, a self-adhesive vapor barrier was produced by applying a pressure-sensitive adhesive layer composed of SBS 3 opposite a glass fiber nonwoven layer to a film support which consists of polyethylene and has had an aluminum layer vapor-deposited thereon and is joined to the glass fiber nonwoven. This product also acts as a vapor barrier and has satisfactory initial adhesion to cement-based substrates containing residual moisture and can have a troweling composition applied on top. However, the troweling composition including the vapor barrier had become detached from the substrate after some days due to the setting stresses in the troweling composition and the unsatisfactory adhesion forces.

### EXAMPLE 5

A self-adhesive vapor barrier was produced in a manner analogous to example 1, but using acrylate 4 instead of SBS 2 as first pressure-sensitive adhesive layer.

This self-adhesive vapor barrier, too, is suitable for application to a cement-based substrate containing residual moisture. Likewise, the one-sided self-adhesive vapor barrier of example 5 remains on the substrate containing residual moisture after accelerated aging, as does a troweling composition applied thereto or an adhesively bonded floor on a cement-based substrate containing residual moisture.

The examples and comparative examples thus confirm, to a person skilled in the art, the importance of the features determined and disclosed which are necessary for successful performance of the invention.

The self-adhesive vapor barrier of the invention can be rolled up into a roll. Rolling is preferably carried out in such a way that the self-adhesive, open side is located on the inside in the roll and after rolling out becomes joined to the substrate and the side to which a troweling composition is to be applied is located at the top.

In addition, an associated covering tape which can serve for areal sealing can be concomitantly used in the system, but overlapping can also be employed instead of this.

The one-sided self-adhesive vapor barrier of the invention can, for example, be applied to new, moisture-resistant substrates, for example cement screeds and/or float-smoothed concrete in the interior sector, and have troweling compositions, e.g. from Uzin Utz AG, for example cement-based troweling compositions and/or calcium sulfate troweling compositions, applied on top and/or have a floor covering directly adhesively bonded thereto by means of conventional adhesives, for example 1K-PU adhesives, 2K-PU adhesives, 2K-epoxy adhesives, MS adhesives and/or dispersion adhesives.

When a vapor seal is required, overlaps and/or a covering tape are preferably employed in order to give impermeable surfaces.

The self-adhesive vapor barrier of the invention can, for example, be applied to raw, cement-based, residually moist, water-resistant, surface-dry, load-bearing, dust-, dirt- and fat-free substrates, for example cement screed, float-smoothed concrete, concrete, etc.

The drying out of concrete floors, composite screeds or floating screeds in buildings requires a lot of time. A screed often requires several weeks of drying time until it is ready to be covered with a troweling composition onto which an elastic floor covering can subsequently be adhesively bonded. Concrete floors often require a drying time of several months. Owing to the high pressure of time, vapor barriers are often employed.

The methods practiced at present are time-consuming and laborious and the materials used are often of concern from the point of view of occupational hygiene. A number of days are often necessary for the work to produce a suitable structure.

A substrate containing residual moisture, preferably one based on cement, can quickly be sealed and made ready for further processing by means of the self-adhesive vapor barriers according to the invention. The self-adhesive vapor barriers according to the invention are suitable for substrates which are not flat and are possibly rough and can be directly covered with troweling compositions or have a floor covering adhesively bonded thereto by means of one or more conventional adhesives.

1. A self-adhesive vapor barrier, comprising:
at least one carrier film;
at least one moisture barrier layer; and
a first pressure-sensitive adhesive layer which is resistant to moisture and is present on a side of the self-adhesive vapor barrier facing the surroundings, wherein a textile structure and optionally a polysiloxane layer and/or another locking-reducing layer and/or a removable covering layer has been applied to the carrier film on a side of the self-adhesive vapor barrier facing the surroundings on the side opposite the first pressure-sensitive adhesive layer and/or the carrier film is structured on the side opposite the first pressure-sensitive adhesive layer and optionally has a polysiloxane layer and/or another locking-reducing layer and/or a removable covering layer,
wherein the first pressure-sensitive adhesive layer has, after application to a moisture-saturated fibrocement sheet, a peel resistance measured by a method based on DIN EN 1939:2003 of ≥3.0 N/25 mm, and
wherein the first pressure-sensitive adhesive layer has a peel resistance measured by a method based on DIN EN 1939:2003 of ≥3.0 N/25 mm after accelerated aging on a moisture-saturated fibrocement sheet for 20 days at 50° C. with retention of the moisture content.

2. The self-adhesive vapor barrier as claimed in claim 1, wherein the moisture barrier layer has an s_{D} value, measured in accordance with ASTM E 398-13, of at least 50 m.

3. The self-adhesive vapor barrier as claimed in claim 1 or 2, which further comprises at least one barrier layer which is impermeable to plasticizers.

4. The self-adhesive vapor barrier as claimed in any of the preceding claims, wherein the at least one moisture barrier layer and/or the optional at least one barrier layer which is impermeable to plasticizers is integrated into the carrier film.

5. The self-adhesive vapor barrier as claimed in any of the preceding claims, wherein the first pressure-sensitive adhesive layer is resistant to alkaline moisture at a pH of equal to or more than 8.0 and equal to or less than 13.5.

6. The self-adhesive vapor barrier as claimed in any of the preceding claims, wherein the at least one moisture barrier layer is present between the at least one carrier film and the textile structure and/or is in contact with the textile structure.

7. The self-adhesive vapor barrier as claimed in any of the preceding claims, wherein the first pressure-sensitive adhesive layer has an adhesive application mass of 10-200 g/m².

8. The self-adhesive vapor barrier as claimed in any of the preceding claims, wherein the carrier film has, in a measurement of the compressive strength in accordance with DIN EN ISO 24343-1, an indentation after static loading of ≤0.1 mm and a permanent indentation after static loading of ≤0.1 mm.

9. The self-adhesive vapor barrier as claimed in any of the preceding claims, which further comprises a removable covering layer which has been applied on the first pressure-sensitive adhesive layer on a side of the self-adhesive vapor barrier facing the surroundings opposite the carrier film, and/or wherein the first pressure-sensitive adhesive layer has an adhesion measured by a method based on DIN EN 1939 of ≤5.0 N/25 mm to the textile structure applied on the carrier film and optional polysiloxane layer and/or other locking-reducing layer and/or the structured surface of the carrier film with optional polysiloxane layer and/or other locking-reducing layer.

10. The self-adhesive vapor barrier as claimed in any of the preceding claims, wherein the textile structure applied to the carrier film and optional polysiloxane layer and/or other locking-reducing layer and/or the structured surface of the carrier film with optional polysiloxane layer and/or other locking-reducing layer has such a nature that, on application of a troweling composition, a dispersion adhesive and/or a reactive adhesive, a peel resistance measured by a method based on EN 1372 of at least 1 N/mm is achieved.

11. The use of a self-adhesive vapor barrier as claimed in any of claims 1 to 10 for laying on a substrate containing residual moisture.

12. The use as claimed in claim 11, wherein the substrate containing residual moisture is a residually moist substrate having a mineral basis and a residual moisture content of more than 1.8 CM-%, measured in accordance with SIA 253:2002.

13. A method for applying a moisture barrier layer to a substrate containing residual moisture, comprising:
application of a self-adhesive vapor barrier as claimed in any of claims 1 to 10 to the substrate containing residual moisture, wherein the first pressure-sensitive adhesive layer is applied to the substrate containing residual moisture, and the removable covering layer or the removable covering layers is/are optionally removed before, during and/or after application of the self-adhesive vapor barrier.

14. The method as claimed in claim 13, wherein a plurality of self-adhesive vapor barriers as claimed in any of claims 1 to 10 are applied in an overlapping manner.

15. The method as claimed in claim 13, wherein a plurality of self-adhesive vapor barriers as claimed in any of claims 1 to 10 are applied so as to adjoin one another and at the adjoining places are joined using at least one one-sided and/or two-sided self-adhesive tape and/or at least one one-sided and/or two-sided self-adhesive tape is applied to the substrate containing residual moisture underneath the adjoining places of the self-adhesive vapor barriers as claimed in any of claims 1 to 10 and the self-adhesive vapor barriers as claimed in any of claims 1 to 10 are applied on top of the at least one one-sided and/or two-sided self-adhesive tape, with the at least one one-sided and/or two-sided self-adhesive tape having at least one moisture barrier layer.

16. The method as claimed in claim 15, wherein the moisture barrier layer of the at least one one-sided and/or two-sided self-adhesive tape has an s_{D} value, measured by a method based on ASTM E 398-13, of at least 50 m.

17. The method as claimed in any of claims 13 to 16, wherein a troweling composition, a dispersion adhesive and/or a reactive adhesive is applied on top of the textile structure applied to the carrier film and optional polysiloxane layer and/or other locking-reducing layer and/or the structured surface of the carrier film with optional polysiloxane layer and/or other locking-reducing layer.
